(19) United States
(12) Patent Application Publication
(10) Pub. No.: US 2018/0203553 A1
(43) Pub. Date: Jul. 19, 2018

(54) Display Module and Display Device

(71) Applicants: BOE Technology Group Co., Ltd., Beijing (CN); Beijing BOE Optoelectronics Technology Co., Ltd., Beijing (CN)

(72) Inventors: Lulu Li, Beijing (CN); Tingting Zhao, Beijing (CN); Haiwei Sun, Beijing (CN); Guangquan Wang, Beijing (CN); Dong Chen, Beijing (CN)

(73) Assignees: BOE Technology Group Co., Ltd., Beijing (CN); Beijing BOE Optoelectronics Technology Co., Ltd., Beijing (CN)

(21) Appl. No.: 15/537,086

(22) PCT Filed: Sep. 27, 2016
(86) PCT No.: PCT/CN2016/100359

§ 371 Date: Jun. 16, 2017

(30) Foreign Application Priority Data
Apr. 14, 2016 (CN) 201610232550.5

(51) Int. Cl. G06F 3/041; G06F 3/044

(52) U.S. Cl. CPC G06F 3/0412; G06F 3/045; G06F 2203/04112; G06F 3/044

(57) ABSTRACT

A display module and a display device are provided. The display module including: a protection cover, a display panel and an electrostatic conducting layer, wherein the electrostatic conducting layer is disposed on a side of the protection cover facing the display panel and configured to conduct static electricity produced by the display module. The display module can improve the antistatic effect of products and hence improve the use characteristics and the competitiveness of the products.

### TECHNICAL FIELD

Embodiments of the present disclosure relate to a display module and a display device.

### BACKGROUND

A display module includes a display panel and a backlight module. When the display module has a large amount of static electricity, the static electricity will result in circuit break of lines in a periphery of the display panel, and then result in abnormal display. Abnormal display, for instance, includes redness, blueness, display abnormally and even being unable to display. A touch display module includes a touch display panel and a backlight module. When the touch display module has a large amount of static electricity, the static electricity will burn out an integrated circuit (IC) of the touch display module or result in circuit break of lines in a periphery of the touch display panel, and will also result in abnormal display.

### SUMMARY

Embodiments of the present disclosure provide a display module and a display device, which are used for improving the antistatic effect of products and hence improving the use characteristics and the competitiveness of the products.

Embodiments of the present disclosure provide a display module, including: a protection cover, a display panel and an electrostatic conducting layer, wherein the electrostatic conducting layer is disposed on a side of the protection cover facing the display panel and configured to conduct static electricity produced by the display module.

Embodiments of the present disclosure further provide a display device, including any one of the display modules provided by embodiments of the present disclosure.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic structural view of an anti-electrostatic discharge (anti-ESD) display module;

FIG. 2 is a schematic structural view of the display module as illustrated in FIG. 1 obtained after being affected by external temperature and humidity environment;

FIG. 3 is a schematic structural view of a display module provided by a first embodiment of the present disclosure;

FIG. 4 is a schematic structural view of a display module provided by a second embodiment of the present disclosure;

FIG. 5 is a schematic structural view of another display module provided by the second embodiment of the present disclosure;

FIG. 6 is a schematic structural view of a touch display module provided by an embodiment of the present disclosure; and

FIG. 7 is a schematic structural view of another touch display module provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “include,” “including,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but can include an electrical connection, directly or indirectly. “On,” “under,” “right,” “left” and the like are only used to indicate relative position relationship, and when the position of the object which is described is changed, the relative position relationship can be changed accordingly.

The thickness of layers and the size and the shape of areas in the accompanying drawings do not reflect the true scale of the layers and are only intended to illustrate the content of the present disclosure.

As illustrated in FIG. 1, a display module includes an array substrate 14 and a color filter (CF) substrate 13 which are opposite to each other, an upper polarizer 12 disposed on a side of the CF substrate 13 facing away from the array substrate 14, a lower polarizer 15 disposed on a side of the array substrate 14 facing away from the CF substrate 13, a protection cover 10 for protecting the array substrate 14 and the CF substrate 13, an optically clear adhesive (OCA) 11 for bonding the protection cover 10 and the upper polarizer 12, and an attaching adhesive 18 for bonding the upper polarizer 12 and the CF substrate 13.

In general, the anti-ESD method adopted for the display module is as follows: conductive particles 17 are doped into the attaching adhesive 18 to prevent electro-static discharge (ESD), and the attaching adhesive 18 becomes a conductive attaching adhesive; the conductive attaching adhesive is electrically connected with a silver adhesive 16 and is connected with a ground wire in the IC (not shown in the figure) on a side of the array substrate 14 through the silver adhesive 16; and the static electricity is discharged through a conductive path from the conductive attaching adhesive to the silver adhesive, so that the anti-ESD effect can be achieved.

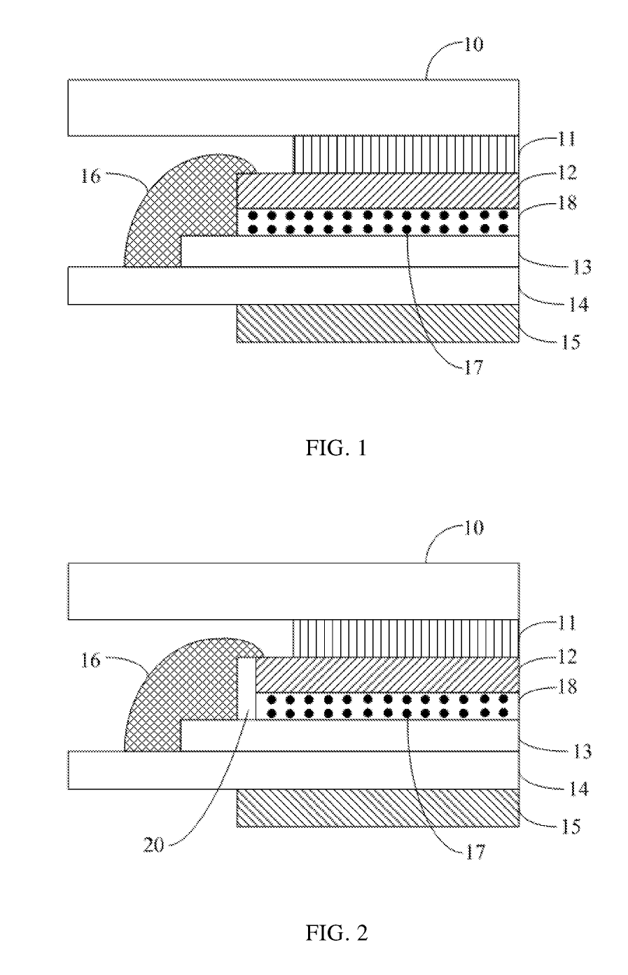

The above method not only has anti-ESD function on the display module but also has anti-ESD function on a touch display module. But in the actual application process, the upper polarizer 12 and the attaching adhesive 18 are susceptible to the external temperature and humidity environment. After being affected by the external temperature and humidity environment, the upper polarizer 12 and the attaching adhesive 18 will be shrunk. As illustrated in FIG. 2, the attaching adhesive 18 will be separated from the silver adhesive 16 after shrinkage, so a gap 20 can be produced. And the conductive path of the conductive attaching adhesive and the silver adhesive is disconnected, so the static electricity produced cannot be well discharged, and hence the anti-ESD effect can be reduced.

Therefore, the anti-ESD effect can be reduced due to the susceptibility to external temperature and humidity environment in the actual application process when the conductive particles are doped into the attaching adhesive to prevent ESD.

Embodiments of the present disclosure provide a display module and a display device, which are used for improving the anti-static effect of products and hence improving the use characteristics and the competitiveness of the products.

The embodiments of the present disclosure provide a display module, which includes: a protection cover, a display panel and an electrostatic conducting layer. The electrostatic conducting layer is disposed on a side of the protection cover facing the display panel and configured to conduct the static electricity produced by the display module.

### First Embodiment

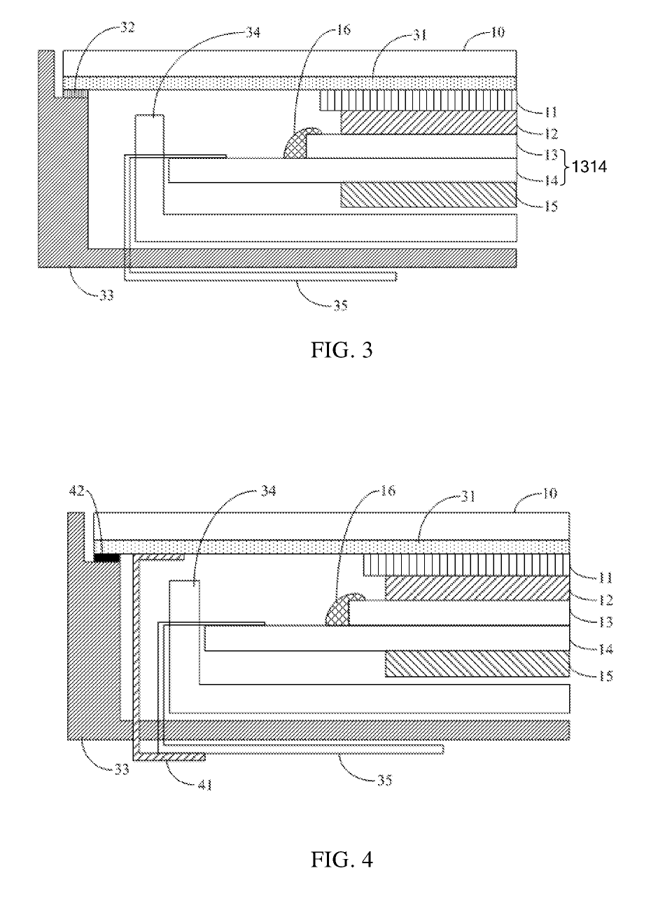

As illustrated in FIG. 3, the embodiment provides a display module, which includes: a protection cover 10, a display panel 1314, an electrostatic conducting layer 31, and a conductive component 32 disposed between the protection cover 10 and a terminal housing 33 of the display module. The display panel 1314 includes an array substrate 14 and an opposing substrate 13 which are opposite to each other. The opposing substrate 13, for instance, is a CF substrate. Of course, a CF layer can also be not disposed on the opposing substrate. The protection cover 10, for instance, is a transparent substrate, e.g., a glass substrate, but not limited thereto.

For instance, the protection cover 10 is disposed on the display panel. The electrostatic conducting layer 31 is disposed on the protection cover 10 and disposed on a side of the protection cover 10 facing the opposing substrate 13. For instance, the electrostatic conducting layer 31 can entirely cover the protection cover. The conductive component 32 is configured to electrically connect the electrostatic conducting layer 31 with the terminal housing 33.

As illustrated in FIG. 3, the display module provided by the embodiment can further include a backlight module 34 and a module flexible printed circuit (FPC) 35. The design of the backlight module 34 and the module FPC 35 can refer to the conventional design. No further description will be given here.

For instance, the terminal housing 33 in the embodiment can be communicated with the outside, e.g., communicated with with the earth. The design of the terminal housing 33 can also refer to the conventional design. For instance, the terminal housing in the embodiment can be a middle bezel of a mobile phone, namely an A shell of the mobile phone.

For instance, the electrostatic conducting layer 31 in the embodiment covers the entire protection cover 10. When the display module provided by the embodiment produces static electricity, the static electricity will be discharged along a path from the electrostatic conducting layer 31, to the conductive component 32, and to the terminal housing 33. Compared with the general ESD path, the embodiment is unsusceptible to the external temperature and humidity environment in the case of discharging static electricity, and hence can improve the antistatic effect of products.

The electrostatic conducting layer in the embodiment covers the entirety of the protection cover. When the display module produces static electricity, the electrostatic conducting layer can play a better role in conducting static electricity. In addition, as the electrostatic conducting layer covers the entire protection cover, a pattern of the electrostatic conducting layer is not required to be formed by a patterning process, etc. Therefore, the electrostatic conducting layer has simple manufacturing process and low production cost, and meanwhile, the manufacturing process will not have a great impact on the entire display module, so that the yield of the display module can be guaranteed. Of course, the pattern of the electrostatic conducting layer can also be formed by a patterning process, etc. No limitation will be given here in the embodiment.

For instance, a material of the electrostatic conducting layer in the embodiment is a transparent conductive material. The transparent conductive material, for instance, includes but not limited to, metal and indium tin oxide (ITO). The electrostatic conducting layer has a square resistance in a range of 10⁸Ω/□ to 10¹⁰Ω/□. The electrostatic conducting layer having the square resistance within this range can better conduct the static electricity produced by the display module in the actual manufacturing process. Moreover, when the electrostatic conducting layer which entirely covers the protection cover has the square resistance in the range of 10⁸Ω/□ to 10¹⁰Ω/□, the display of the display module will not be affected. In the actual manufacturing process, the resistance of the electrostatic conducting layer can be set according to processes and actual demands. No limitation will be given to the resistance of the electrostatic conducting layer in the embodiment.

For instance, as illustrated in FIG. 3, in the embodiment, an electrostatic conducting layer 31 can be sputtered on a side of the protection cover 10 facing the opposing substrate 13 by film sputtering. Of course, in the actual manufacturing process, the electrostatic conducting layer 31 can also be disposed on the side of the protection cover 10 facing the opposing substrate 13 by other means. For instance, an electrostatic conducting layer 31 is sprayed on a side of the protection cover 10 facing the opposing substrate 13 by spray coating.

For instance, the conductive component 32 in the embodiment is conductive foam or a conductive adhesive. Of course, the conductive component in the embodiment can also adopt other conductive materials. No limitation will be given here to the specific materials of the conductive component.

In the embodiment, the electrostatic conducting layer is disposed on a side of the protection cover facing the opposing substrate, and the conductive component is disposed between the protection cover and the terminal housing. During actual production, as the terminal housing is communicated with the outside, e.g., communicated with the earth, the static electricity produced by the display module provided by the embodiment will be discharged along a path from the electrostatic conducting layer, to the conductive component, and to the terminal housing. Compared with the general ESD path, the display module provided by the embodiment is unsusceptible to the external temperature and humidity environment in the case of discharging static electricity, and hence can improve the antistatic effect of products.

### Second Embodiment

As illustrated in FIG. 4, the display module provided by the embodiment further includes a button FPC 41. The button FPC 41 is configured to electrically connect the electrostatic conducting layer 31 and the module FPC 35 of the display module. The structural design of the button FPC 41 in the embodiment can refer to conventional design. the button FPC 41 is in contact with the protection cover 10.

As illustrated in FIG. 4, when the display module provided by the embodiment includes the button FPC 41, namely the display module provided by the embodiment needs to be bounded with the button FPC 41, if the display module products static electricity, the static electricity can be discharged along a path from the electrostatic conducting layer 31, a ground (GND) line on the button FPC 41, and to a GND line on the module FPC 35. Compared with the general ESD path, the display module provided by the embodiment is unsusceptible to the external temperature and humidity environment in the case of discharging static electricity, and hence can improve the antistatic effect of products. In this case, the protection cover 10 and the terminal housing 33 can be subjected to dispensing by dispensing technology. The protection cover 10 and the terminal housing 33 can be connected with each other through glue 42 dispensed by the dispensing technology.

For instance, the electrostatic conducting layer 31 in the embodiment covers an entirety of the protection cover 10. When the display module produces static electricity, the electrostatic conducting layer can play a better role in conducting static electricity. In addition, as the electrostatic conducting layer covers the entirety of protection cover, a pattern of the electrostatic conducting layer is not required to be formed by a patterning process, etc. Therefore, the electrostatic conducting layer has simple manufacturing process and low production cost, and meanwhile, the manufacturing process will not have a great impact on the entire display module, so that the yield of the display module can be guaranteed.

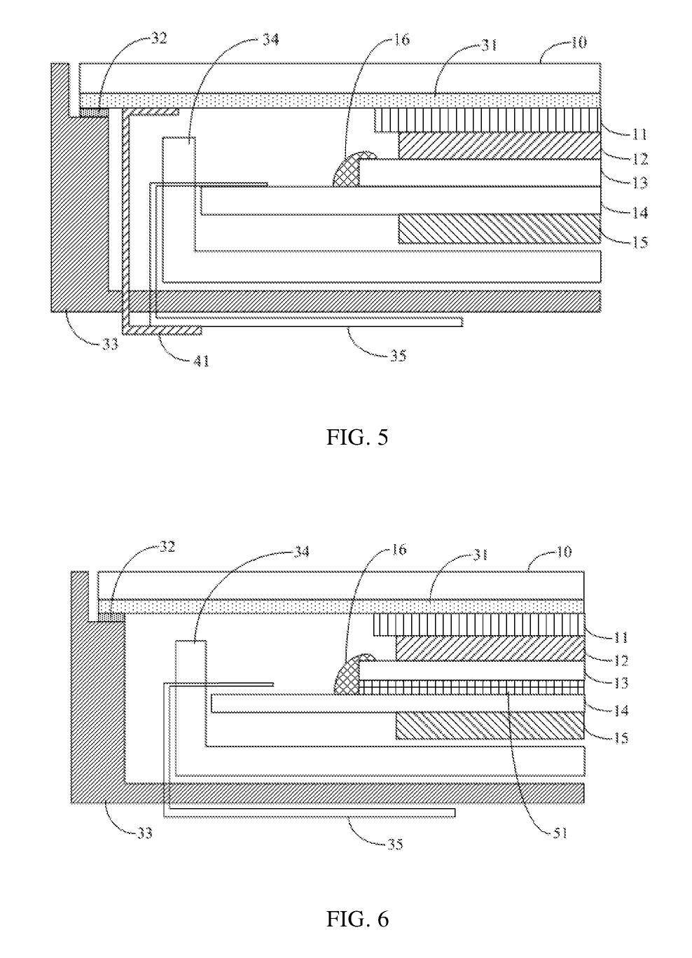

As illustrated in FIG. 5, the display module provided by one example of the embodiment can further include a conductive component 32 disposed between the protection cover 10 and the terminal housing 33. The conductive component 32 is configured to electrically connect the electrostatic conducting layer 31 and the terminal housing 33. For instance, the conductive component 32 in the embodiment can be conductive foam or a conductive adhesive. Of course, the conductive component can also adopt other conductive materials. No limitation will be given here to the specific materials of the conductive component.

As illustrated in FIG. 5, when the display module products static electricity, the static electricity not only can be discharged along a path from the electrostatic conducting layer 31, to the conductive component 32, and to the terminal housing 33, but also can be discharged along a path from the electrostatic conducting layer 31, to a GND line on the button FPC 41, and to a GND line on the module FPC 35. Thus, the static electricity produced by the display module can be better discharged. Compared with the general ESD path, the display module provided by the embodiment is unsusceptible to the external temperature and humidity environment in the case of discharging static electricity, and hence can improve the antistatic effect of products.

For instance, a material of the electrostatic conducting layer in the embodiment can be a transparent conductive material. The electrostatic conducting layer has a square resistance in a range of 10⁸Ω/□ to 10¹⁰Ω/□. Of course, in the actual manufacturing process, the resistance of the electrostatic conducting layer can be set according to processes and actual demands. No limitation will be given to the specific resistance of the electrostatic conducting layer in the embodiment.

The display module provided by the embodiment can be a touch display module having touch function. Description will be given below to the discharge process of the static electricity, produced by the touch display module provided by the embodiment, with reference to the accompanying drawings.

As illustrated in FIG. 6, the touch display module provided by one example of the embodiment includes touch electrodes 51 disposed between the array substrate 14 and the opposing substrate 13. The touch display module provided by the embodiment further includes an electrostatic conducting layer 31 and a conductive component 32 disposed between a protection cover 10 and a terminal housing 33. The electrostatic conducting layer 31 is disposed on a side of the protection cover 10 facing the opposing substrate 13. The conductive component 32 is configured to electrically connect the electrostatic conducting layer 31 with the terminal housing 33.

The static electricity produced by the touch display module provided by the example can be discharged along a path from the electrostatic conducting layer 31, to the conductive component 32, and to the terminal housing 33. Compared with the general ESD path, the touch display module provided by the embodiment is unsusceptible to the external temperature and humidity environment in the case of discharging static electricity, and hence can improve the antistatic effect of products.

For instance, as illustrated in FIG. 6, the touch electrodes 51, disposed between the array substrate and the opposing substrate, in the embodiment can be self-capacitive touch electrodes and can also be mutual-capacitance touch electrodes. When the touch electrodes are self-capacitive touch electrodes, the self-capacitive touch electrodes can be disposed on a side of the array substrate facing the opposing substrate and can also be disposed on a side of the opposing substrate facing the array substrate. The self-capacitive touch electrodes can refer to conventional design. No further description will be given here.

When the touch electrodes are mutual-capacitance touch electrodes, both driving electrodes and sensing electrodes can be disposed on a side of the array substrate facing the opposing substrate; or both the driving electrodes and the sensing electrodes can be disposed on a side of the opposing substrate facing the array substrate; or the driving electrodes can be disposed on a side of the array substrate facing the opposing substrate, and the sensing electrodes can be disposed on a side of the opposing substrate facing the array substrate. The mutual-capacitance touch electrodes can refer to conventional design. No further description will be given here.

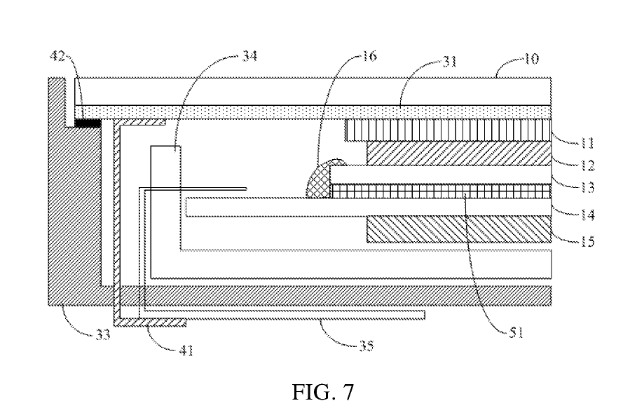

As illustrated in FIG. 7, the touch display module provided by one example of the embodiment further includes a button FPC 41. The FPC 41 is configured to electrically connect the electrostatic conducting layer 31 with the module FPC 35 of the display module.

And then, the static electricity produced by the touch display module provided by the example can be discharged along a path from the electrostatic conducting layer 31, to a GND line on the button FPC 41, and to a GND line on the module FPC 35. Compared with the general ESD path, the touch display module provided the embodiment is unsusceptible to the external temperature and humidity environment in the case of discharging static electricity, and hence can improve the antistatic effect of products.

In addition, the touch display module provided by the embodiment can further include a conductive component 32 disposed between the protection cover 10 and the terminal housing 33. The conductive component 32 can be as illustrated in FIG. 5. The static electricity produced by the touch display module provided by the embodiment can be discharged not only along a path from the electrostatic conducting layer 31, to the conductive component 32, and to the terminal housing 33, but also along a path from the electrostatic conducting layer 31, to the GND line on the button FPC 41, and to the GND line on the module FPC 35. Compared with the general ESD path, the touch display module provided by the embodiment is unsusceptible to the external temperature and humidity environment in the case of discharging static electricity, and hence can improve the antistatic effect of products.

### Third Embodiment

The embodiment provides a display device, which includes the foregoing display module. The display device can be a liquid crystal display (LCD) panel, an LCD, an LCD TV, an organic light-emitting diode (OLED) panel, an OLED display, an OLED TV, e-paper, etc.

In summary, the embodiments provide a display module, which includes: a protection cover and a display panel, and further include an electrostatic conducting layer. The electrostatic conducting layer is disposed on a side of the protection cover facing the display panel and configured to conduct static electricity produced by the display module. As the electrostatic conducting layer is disposed on a side of the protection cover facing the display panel in the embodiment of the present disclosure, and the electrostatic conducting layer is configured to conduct the static electricity produced by the display module, the static electricity produced by the display module provided by the embodiments can be discharged through the electrostatic conducting layer. Compared with the case of discharging static electricity through the conductive attaching adhesive and the silver adhesive in conventional design, the display module provided by the embodiments can improve the anti-ESD effect of products as the electrostatic conducting layer is unsusceptible to the external temperature and humidity environment in the case of discharging static electricity, and hence can improve the use characteristics and the competitiveness of the products.

In the embodiments of the present disclosure, the same reference numerals denote the same elements/components unless otherwise defined, and the features in different embodiments or different features in the same embodiments can be combined without conflict.

What have been described above are only specific implementations of the present disclosure, the protection scope of the present disclosure is not limited thereto. Any changes or substitutions easily occur to those skilled in the art within the technical scope of the present disclosure should be covered in the protection scope of the present disclosure. Therefore, the protection scope of the present disclosure should be based on the protection scope of the claims.

This application claims the benefit of priority from Chinese patent application No. 201610232550.5, filed on Apr. 14, 2016, the disclosure of which is incorporated herein in its entirety by reference as a part of the present application.

1. A display module, comprising: a protection cover, a display panel and an electrostatic conducting layer, wherein the electrostatic conducting layer is disposed on a side of the protection cover facing the display panel and configured to conduct static electricity produced by the display module.

2. The display module according to claim 1, wherein the electrostatic conducting layer covers an entirety of the protection cover.

3. The display module according to claim 2, further comprising a conductive component disposed between the protection cover and a terminal housing of the display module, wherein the conductive component is configured to electrically connect the electrostatic conducting layer with the terminal housing.

4. The display module according to claim 2, further comprising a module flexible printed circuit (FPC) and a button FPC, wherein the button FPC is configured to electrically connect the electrostatic conducting layer with the module FPC.

5. The display module according to claim 3, wherein the conductive component is conductive foam or a conductive adhesive.

6. The display module according to claim 2, wherein a material of the electrostatic conducting layer is a transparent conductive material.

7. The display module according to claim 6, wherein the electrostatic conducting layer has a square resistance in a range of 10⁸Ω-10¹⁰Ω.

8. The display module according to claim 1, wherein the display module is a touch display module, and comprises an array substrate, an opposing substrate and touch electrodes disposed between the array substrate and the opposing substrate.

9. A display device, comprising the display module according to claim 1.

10. The display module according to claim 3, further comprising a module flexible printed circuit (FPC) and a button FPC, wherein the button FPC is configured to electrically connect the electrostatic conducting layer with the module FPC.

11. The display module according to claim 3, wherein the display panel is disposed between the protection cover and the terminal housing.

12. The display module according to claim 3, wherein a backlight module is disposed between the terminal housing and the display panel.

13. The display module according to claim 6, wherein the transparent conductive material is metal or indium tin oxide.

14. The display module according to claim 8, further comprising an upper polarizer, wherein the upper polarizer is disposed on a side of the opposing substrate facing away from the array substrate, and the electrostatic conducting layer is connected with the upper polarizer by an optically clear adhesive.

15. The display module according to claim 8, further comprising a lower polarizer, wherein the lower polarizer is disposed on a side of the array substrate facing away from the opposing substrate.
